(19) United States
(12) Patent Application Publication
(10) Pub. No.: US 2023/0271212 A1
(43) Pub. Date: Aug. 31, 2023

(54) MOBILE COATING UNIT TO PRODUCE VARIOUS, CHANGEABLE COATED PROPPANTS WITH ARTIFICIAL INTELLIGENCE OPTION, CONFIGURATION AND METHOD OF USE

(71) Applicant: Aquasmart Enterprises, LLC, Midland, TX (US)

(72) Inventors: Calder Hendrickson, Midland, TX (US); Todd Naff, Bryan, TX (US); Oliver Mulamba, Lubbock, TX (US)

(21) Appl. No.: 18/117,008

(22) Filed: Mar. 3, 2023

Related U.S. Application Data
(63) Continuation-in-part of application No. 17/580,374, filed on Jan. 20, 2022.
(60) Provisional application No. 63/139,913, filed on Jan. 21, 2021.
(60) Provisional application No. 63/316,384, filed on Mar. 3, 2022.
(60) Provisional application No. 63/434,000, filed on Dec. 20, 2022.

(51) Int. Cl. B05B 13/02; B01F 35/75; B01F 35/222

(52) U.S. Cl. CPC B05B 13/0221; B01F 35/75; B01F 35/222

(57) ABSTRACT

A method for improving the performance of hydraulic fracturing processes in oil production fields wherein modifiable coated proppants used in the fracturing fluid are produced on a well-site. Various types of coated proppants may be produced based on real-time, down-hole information obtained and utilized at the well-site.

### RELATED APPLICATIONS

This application is a continuation-in-part of U.S. utility patent application Ser. No. 17/580,374, filed Jan. 20, 2022, which claims the benefit of U.S. provisional patent application Ser. No. 63/139,913, filed Jan. 21, 2021; and claims the benefit of U.S. provisional patent application Ser. No. 63/316,384, filed Mar. 3, 2022; and claims the benefit of U.S. provisional patent application Ser. No. 63/434,000, filed Dec. 20, 2022; all of which are hereby incorporated herein by reference in their entireties.

### BACKGROUND

### The Field of the Invention

This invention relates to oil and gas field and oil and gas well development, and, more particularly, to novel systems and methods for providing coated proppants at a well-site for hydraulic fracturing and propping fissures in oil and gas-bearing formations.

### The Background Art

Oil and gas well development has over one hundred years of extensive engineering and chemical improvements intended to address the varied issues that can arise from well to well, and within a single well. There is extreme variability between separate wells. This variability is based on, but not limited to, the following factors: the location of the well, which basin; the type of well, which formation; the type of water being used, fresh, produced, mixed; the depth of the well; the temperature of the well; the typical treating pressure of the well; the pore pressure gradient; and how readily the formation will take proppant.

There is also extreme variability within a single well. This variability is based on, but not limited to, the following factors: completing a heel stage of the well, which is closer to the vertical part of the well and usually has lower treating pressures and less distance to transport proppant; and completing a toe stage of the well, which is farther from the vertical part of the well and usually has higher treating pressures and much greater distances to transport proppant (i.e., approximately 3 miles or more).

There can also be extreme variability depending on the completion design of a well. This variability is based on, but not limited to, the following factors: barrels of water per foot; pounds of sand per foot; stage length in linear feet; number of clusters and spacing; pump rate in barrels per minute; sand loading in pounds per gallon; sand pump rate; and friction reducer dosage in gallons per thousand gallons, or pounds per thousand gallons.

Various methods for stimulating production of well bores associated with an oil and gas reservoir have been developed. Different types of processes may require various treatments. In general, well production can be improved by fracturing formations. Fracturing is typically done by pumping a formation full of a fluid, containing a large fraction of water, and pressurizing that fluid in order to apply large surface forces to parts of the formation. These large surface forces cause stresses, and by virtue of the massive areas involved, can produce extremely high forces and stresses in the rock formations.

Accordingly, the rock formations tend to shatter, increasing permeability and providing space for the production oil and gas to pass through the formation toward the bore hole for extraction. Moreover, various techniques exist to further improve the fracture networks, such as acidizing. However, as the foregoing implies, the process is not simple, and the incorporation of various materials into mixtures is time, money, energy, and other resource intensive. Nevertheless, these mixtures are critical to the mission—transport proppant into the fractures to prop open the formation, and provide pathways for oil and gas to migrate back into the well-bore.

It would be an advance in the art if such resources could be more efficiently deployed by utilizing an improved composition and method for incorporating materials into mixtures.

Moreover, hydraulic fracturing has a rather sophisticated process for adding various constituents to the fracking fluids. Not only must proppants be added, but various other chemicals. In fracturing processes, it is necessary to blend materials to create the working fluid for fracturing, or “slurry.” Such blending requires substantial equipment, occupying a significant footprint on the overall well-site.

Moreover, this equipment requires manpower, and maintenance of numerous receiving and storage areas. These are needed for various constituent products that will ultimately be added to the working fluid. All of these processes for mixing auxiliary materials into the fluid can cause delays in time. Powdered materials, for example, can prove very difficult to incorporate.

Particularly with small particles, surface tension tends to float such materials on the surface of liquids and require substantial mixing and substantial associated time. Many solids must be pre-mixed in oils, emulsions, and the like, increasing the effect of any spill. Meanwhile, addition of chemicals to a fracturing flow necessarily creates uneven distributions of additives. For example, upon addition into the flow, a constituent is at a very high concentration near the well head. Meanwhile, none of that newly added constituent exists elsewhere. Thus, the ability to thoroughly distribute material, or to even get it distributed well throughout the fluid being introduced, has proven difficult.

Similarly, transportation of individual constituent chemicals and materials to the well site requires multiple vehicles specialized to different types of materials and phases. For example, some materials are fluids, some are solids, some use a water solvent, some use a petroleum-based solvent, and such materials must be hauled, delivered, and handled in distinct ways with their own suitable storage, handling, and transport equipment.

Various complaints have been encountered with the amount of hydrocarbons, such as various emulsions, chemical additives, including such materials as diesel fuel and the like that are often used. With such liquid chemicals on site, the risk of surface contamination due to chemical spills of such materials is increased. Even when contained in smaller containers, such materials run the risk of spills, carrying about by water, wind, and other weather, as well as the prospect of possible spilling during delivery, handling, or the feeding and mixing processes.

Meanwhile, the operational footprint required for storage, mixing systems, receiving, shipping, and the like increase the overall operational footprint of a well site. Moreover, money, labor, and time are substantial for the process of receiving, preparation, storage, handling, and ultimately mixing materials that will be added to a fracturing fluid.

Thus, it would be an advance in the art to provide a system and method that would eliminate many of the handling, equipment, footprint, transportation, and other problems inherent with existing materials and mixing systems to service fracture fluids.

One process for addressing many of these issues is the use of coated proppant products, of which there are several on the market. Generally, these coated proppant products are resin coated proppants that may have several different types of functionality. These coated proppant products are usually created off the well-site and then transported to the site where they are used. This forces the consumer to choose what product functionality they desire prior to using the product, and once these products are coated, there is no opportunity to change their functionality. The result is that a consumer, or operator company, can attempt to pre-determine what conditions they are most likely to encounter at a particular well-site and attempt to select the necessary functionality to address all aspects of the pre-determined variability spectrum. Another option under this system is to select a product that addresses the worst-case scenario, which can result in the use of an over-engineered product that wastes active input components and drives up the costs of using such a product.

Coating proppant products off-site adds certain logistical and handling costs because the most vulnerable time for coated proppant products is during the logistics and handling process. Proppants are typically delivered to a well-site either via pneumatic truck or some sort of box system. Proppants delivered by pneumatic truck are off-loaded into on-site sand silos that feed the blender. Proppants delivered by box are unloaded by belt directly into the blender. Typically, all proppants must be kept dry prior to introduction into the blender. Coated proppant products can activate when they come into contact with moisture, which can ruin some products and cause aggravation on-site with other products when attempting to load the blender.

Given the various factors involved, it is highly unlikely that coated proppant products created off-site, in advance of the specific situation to be addressed, and unable to change or adapt, could effectively and efficiently provide the necessary performance characteristics.

Thus, it would be an advance in the art to provide a system and method of use that connects physically and electronically to existing hydraulic fracturing fleet equipment, is driven by real-time data from the on-site data van, and utilizes the information from the data van to create an optimal coated proppant product. Moreover, it would be an advance in the art to provide a system and method that can produce a variety of coated proppant products to address specific real-time, down-hole conditions at a well-site. Also, the system could adjust to provide coated proppants at substantially the same rate that the associated down-hole conditions change.

It would be a substantial advance in the art to provide a system and method that would optimize the use of various materials used as additives in fracture fluids and provide real-time adjustments to coated proppant products, and thus to fracture fluids, based on current well conditions. Moreover, this can be done on-site just prior to the addition of the newly produced coated proppant products into the blender.

The space available for equipment and supplies is a major concern at a well-site. There can be very limited space available at some well-sites, so much so that it may not be possible to add another piece of equipment. It would be a substantial advance in the art to provide a system that would minimize the space occupied by a proppant coating system. A proppant coating system may be modified to occupy a minimum amount of space at a well-site. A proppant coating system may be incorporated into, or function in conjunction with, appropriate equipment that is already available at a well-site.

### BRIEF SUMMARY OF THE INVENTION

In view of the foregoing, in accordance with the invention as embodied and broadly described herein, a method, apparatus, and composition are disclosed in certain embodiments in accordance with the present invention.

Not surprisingly, an oil and gas well routinely costs multiple millions of dollars. Accordingly, an exorbitant amount of time and planning is devoted to the “completion” process of an oil and gas well. The completion process can involve multiple processes, including hydraulic fracturing, or fracing. Hydraulic fracturing is a highly planned process. The plan used during a specific hydraulic fracturing process for a given well may be called a “frac design” or “frac plan.”

The development of a frac design is a detailed and time-consuming process. Extensive analysis is conducted on existing wells within a reasonable geographic area. The comparison and/or contrast may narrow by basin and formation, so that information regarding what has worked or not worked before can be utilized to maximize the return on investment an “operator” company can realize from each well.

Completion and Reservoir Engineers evaluate the available data and perform the necessary analysis to develop a frac design for a given well. That frac design usually splits the completion process into separate “stages,” and a modern frac design may include sixty or more such stages. Each stage will have a PAD phase that is only liquid. The purpose of the PAD is to initiate the fractures. After the PAD, the completion crew begins to add sand and/or proppant to the liquid. The amount of sand is slowly ramped up according to a schedule that is followed until the desired amount of sand for that stage is placed. To complete a stage, a “flush” is generally pumped. The flush is only liquid and is primarily intended to remove any excess sand from the well-bore.

A mobile coating unit, or on-site intelligent coating system, enables the creation of custom coated proppants at a well-site. Generally, a coated proppant comprises a substrate and a coating of the substrate. A substrate may be formed of sand, rock product, ceramic sand, gravel, fibers, or other similar materials. When used herein any reference to proppant or sand generally refers to any or all of these used in accordance with the invention. These coated proppants may include powder or liquid versions of one or more of, a friction reducer, a surfactant, a scale inhibitor, a biocide, a viscosifier (for example and without limitation, guar, HEC, polysaccharides, xanthan), a breaker, a cross-linker, a buffer, a clay stabilizer, or the like.

The on-site aspect of such a mobile coating unit is very advantageous, even necessary, due to the logistical limitations and costs for the customers associated with coating proppant products at any off-site location. Also, there is great value in the ability to vary the coating during the fracturing process based on the real-time, down-hole conditions being experienced in order to create the most efficient, productive well completion. With many of the fracturing inputs being dependent on the volume of sand, introducing these with the coatings that are sand volume driven allows for increased efficiencies and better overall control. With some of the larger operator companies using wet sand, mined close to the fracturing site, a robust system able to be introduced effectively into either the sand silo feed or the wet sand feed creates value and simplicity that has not previously existed.

A mobile coating unit for producing custom coated proppants at a well-site, or fracturing site, may be inserted between the sand source and the blender at the well-site. The mobile coating unit may receive data input and operational instructions from either or both of the well-site frac van or the mobile coating unit's PLC control unit. Such inputs can provide a rate of throughput that the system can use to determine its input rates to create the desired coated proppant. The throughput rates are variable, as are the inputs and input rates. The mobile coating unit may accommodate both wet and dry proppants, which enables a previously unavailable flexibility when considering proppant supply options.

The inclusion of multiple necessary fracturing inputs in a manner balanced by the proppant volume and in response to real-time conditions ensures that only the necessary chemicals will be introduced down-hole. For example, use of the mobile coating unit and methods of operation described herein by an operator company could reduce the volume of chemical fluid put down-hole by over five million pounds over the course of a year. The ESG (environment, social and governance) benefits of such reductions can add up quickly. The economic benefits are obvious. All hydraulic fracturing operations can include tumultuous peaks and calm valleys. The coating approach described herein can address these fluctuations, but the ability to tailor coated proppants during the operation adds another level of specificity and efficiency that controls what goes down-hole, thus minimizing waste and maximizing well health.

Utilizing a mobile coating unit as described herein provides numerous benefits. There are no additional, logistics, or transportation costs and handling issues associated with coated proppant products produced off-site because the coated proppants are produced at the well-site. This can also reduce traffic on the well-site, and on roads generally, because chemicals or additives used by the mobile coating unit may be contained within or connected to the coating unit. Proppant or sand from the well-site may be used by the mobile coating unit, which allows the operator company to use sand from any mine they choose and eliminates any need to ship raw sand from one mine to another to be coated, and eliminates the need to set up coating operations at every sand mine. The transport and logistical costs associated with moving sand can be significant, so a mobile coating unit on a well-site can virtually eliminate such costs. A mobile coating unit can primarily use powdered additives, which can virtually eliminate the use of liquids and their associated space, handling, and efficiency issues. The coated proppant from the mobile coating unit may carry a more exact dosing of needed chemicals, which may reduce waste and reduce the total amount of chemicals going down-hole. The mobile coating unit may run a desired fracturing design and make tweaks to the process as the available real-time data informs the coating process. The ability to modify or completely change the coating formula for coated proppant based on real-time down-hole conditions eliminates the need for a “one coating fits all” option and can help produce an optimal completion stage to a well. Also, the use of a mobile coating unit is relatively easy from a permitting and procedural standpoint. A fixed location coating facility can take 6-12 months, cost thousands of dollars, and require completion of multiple intensive studies. Adding a mobile coating unit could simply require and addendum to an operator company's, or manufacturer's, existing permit for the period of time that the mobile coating unit was on-site.

In one embodiment, a method for producing a coated proppant may comprise: providing a mobile coating unit, wherein the mobile coating unit comprises a platform having a proximal end and a distal end, a liquid additive dispenser supported by the platform, a volumetric powder dispenser supported by the platform, a coating mixer supported by the platform, and a control unit supported by the platform and operably connected to the liquid additive dispenser, the volumetric powder dispenser, and the coating mixer; positioning the mobile coating unit on a well-site; feeding proppant to the mobile coating unit at the proximal end of the platform; coating the proppant in accordance with a first formula programmed into the control unit to produce a first coated proppant; dispensing the first coated proppant from the mobile coating unit at the distal end of the platform; transferring the first coated proppant to a blender that is on the well-site; adding the first coated proppant to a first fracturing fluid; pumping the first fracturing fluid into a well head in less than five (5) days from the completion of the coating of the first coated proppant; coating the proppant in accordance with a second formula programmed into the control unit to produce a second coated proppant; dispensing the second coated proppant from the mobile coating unit at the distal end of the platform; transferring the second coated proppant to the blender that is on the well-site; adding the second coated proppant to a second fracturing fluid; and, pumping the second fracturing fluid into the well head in less than five (5) days from the completion of the coating of the second coated proppant.

In one embodiment, a method for coating a proppant may comprise: providing a mobile coating unit, wherein the mobile coating unit comprises a platform having a proximal end and a distal end, one or more liquid additive dispensers supported by the platform, one or more volumetric powder dispensers supported by the platform, one or more coating mixers supported by the platform, and a control unit supported by the platform and operably connected to the liquid additive dispensers, the volumetric powder dispensers, and the coating mixers; feeding proppant to the mobile coating unit at the proximal end of the platform; coating a first portion of the proppant in accordance with a first formula programmed into the control unit to produce a first coated proppant; dispensing the first coated proppant from the mobile coating unit at the distal end of the platform; coating a second portion of the proppant in accordance with a second formula programmed into the control unit to produce a second coated proppant; and dispensing the second coated proppant from the mobile coating unit at the distal end of the platform in less than twelve (12) hours after the completion of the coating of the first proppant.

Also, the method may further comprise: transferring, after the completion of the coating of the first coated proppant, the first coated proppant to a blender that is on a well-site; adding the first coated proppant to a first fracturing fluid; pumping the first fracturing fluid into a well head in less than 48 hours from the completion of the coating of the first coated proppant; transferring, after the completion of the coating of the second coated proppant, the second coated proppant to the blender that is on the well-site; adding the second coated proppant to a second fracturing fluid; and pumping the second fracturing fluid into the well head in less than 48 hours from the completion of the coating of the second coated proppant.

In one embodiment, a method for controlling a proppant coating process at a well-site may comprise: providing a frac van on a well-site, wherein the frac van comprises a frac control system that monitors real-time, down-hole conditions in the well and is programmed with a frac plan for the well-site; providing a mobile coating unit at the well-site, wherein the mobile coating unit is operably connected to the frac control system and the mobile coating unit comprises a platform having a proximal end and a distal end, one or more liquid additive dispensers supported by the platform, one or more volumetric powder dispensers supported by the platform, one or more coating mixers supported by the platform, and a control unit supported by the platform and operably connected to the liquid additive dispensers, the volumetric powder dispensers, and the coating mixers; positioning the mobile coating unit on the well-site between a source of proppant and a blender with the platform's proximal end toward the source of proppant and the platform's distal end toward the blender; controlling coating operations of the mobile coating unit based on real-time, down-hole conditions monitored by the frac control system, wherein the frac control system selects a first formula that is communicated to the mobile coating unit control unit and produces a first coated proppant; and adjusting coating operations of the mobile coating unit based on real-time, down-hole conditions monitored by the frac control system, wherein the frac control system selects a second formula that is communicated to the mobile coating unit control unit and produces a second coated proppant.

In one embodiment, a system for coating sand, or another proppant, may comprise: a sand carrier that is operably connected to transport an amount of sand to a coating mixer, wherein the coating mixer comprises a vertical exit that dispenses coated sand; a liquid additive dispenser that is operably connected to spray a liquid additive onto the amount of sand before the amount of sand is transported into the coating mixer; a volumetric powder dispenser that is operably connected to add an amount of powder additive to the coating mixer; a control unit that is operably connected to the sand carrier, the liquid additive dispenser, the volumetric powder dispenser, and the coating mixer, and the scaffold defines a footprint for the system.

The system may be further comprised of a charge hopper that is operably connected to provide sand to the sand carrier, and the charge hopper is also operably connected to the control unit. The system may be further comprised of a sand elevator that is operably connected to provide sand to the charge hopper. The system may be further comprised of at least two powder additive silos that are operably connected to provide powder additives to the volumetric powder dispenser, and at least two liquid additives that can be sprayed by the liquid additive dispenser. The control unit of the system may be operably connected to a frac van, or data van, at the well-site. The system may be set up such that the vertical exit from the coating mixer is at least ten feet above the ground where the system is located. The system may be set up such that the vertical exit is from approximately three feet to approximately fifteen feet above the ground. The footprint of the system may be less than about ten feet wide and about sixty feet long. The footprint of the system may be less than about ten feet wide and about fifty feet long. The footprint of the system may be less than about ten feet wide and about forty feet long. The system may be designed to be transportable, or mobile. The system may be configured to be contained in a single container, or multiple containers, wherein each container may include a desired number of system components and each container may be transportable, or mobile.

In one embodiment, a system may be incorporated into, or function in conjunction with, appropriate equipment that is present at a well-site. For example and not by way of limitation, the necessary components for a coating system may be incorporated into a large, conical mixer, or silo mixer. Appropriate additive feeders could be operably connected to a conical mixer or silo mixer. For example, tackifiers and/or liquid additives could be introduced into a silo mixer through nozzles affixed at or near the top of the silo mixer, wherein the nozzles are from liquid additive dispensers. Powder additives could be introduced into a silo mixer from a volumetric powder dispenser affixed at or near the top of the silo mixer. Similarly, the necessary components for a coating system may be configured to function in conjunction with sand storage boxes and a rack used with the boxes.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic diagram of a typical well site;

FIG. 2 is a schematic diagram of a well site utilizing a mobile coating unit in accordance with the invention;

FIG. 3 is a schematic diagram top plan view of a mobile coating unit in accordance with the invention;

FIG. 4 is a schematic diagram side view of a mobile coating unit in accordance with the invention, wherein certain dashed lines are used to better illustrate other portions of the mobile coating unit;

FIG. 5a is a schematic diagram illustrating a testing procedure for evaluating erosion driven weight loss of certain proppants;

FIG. 5b is a graph and table illustrating results of a testing procedure for evaluating erosion driven weight loss of certain proppants;

FIG. 6a is a schematic diagram illustrating a testing procedure for evaluating pressure changes with certain proppants;

FIG. 6b is a graph illustrating results of a testing procedure for evaluating pressure changes with certain proppants;

FIG. 6c is a graph illustrating results of a testing procedure for evaluating pressure changes with certain proppants;

FIG. 6d is a graph illustrating results of a testing procedure for evaluating pressure changes with certain proppants;

FIG. 7 is a flow diagram illustrating a method of use in accordance with the invention;

FIG. 8 is a perspective diagram of a coating system in a substantially vertical configuration;

FIG. 9 is a schematic diagram side view of a coating system in a substantially vertical configuration;

FIG. 10a is a schematic diagram top plan view of one level of a coating system;

FIG. 10b is a schematic diagram top plan view of another level of a coating system;

FIG. 11 is a perspective diagram of an embodiment of a coating system utilizing a silo; and

FIG. 12 is a schematic diagram of an embodiment of a coating system utilizing a silo-mixer.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

An oil and gas well may have a variety of equipment set up at a well-site in various configurations. Such configurations can vary from well-site to well-site and depend on the type of well, topography of the well-site, equipment and materials needed, and other, similar factors.

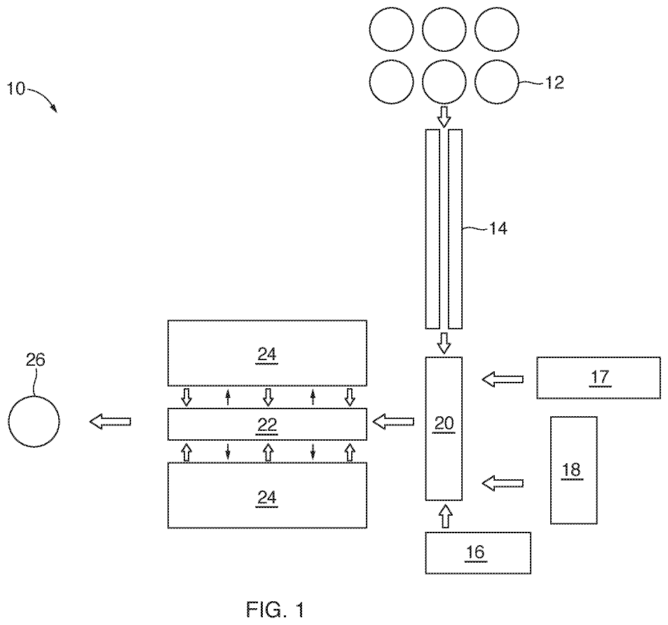

Referring to FIG. 1, a customary or typical well-site configuration 10 is depicted in the schematic diagram. A well-site configuration 10 may include silos or boxes for sand storage 12, or proppant storage 12. Sand is a typical proppant material, but any material suitable for use as a proppant may be utilized. A suitable proppant, or substrate, may include sand (dry or wet—with moisture content ranging from 0-15%), ceramic proppant, resin-coated proppant, fibers, or the like.

A sand conveyor 14 may be operably connected to a sand storage 12 silo at one end and to a blender 20 at the other end by any suitable means that enables the transfer of the sand from the sand storage 12 to the blender 20. A sand conveyor 14 may be a belt-scale that can weigh the sand being transported from the sand storage 12 to the blender 20.

A blender 20 may be used to mix and prepare the sand and fracturing fluid to be delivered to a manifold 22. The blender 20 may be operably connected to any materials that are needed or used in the process of preparing the fracturing fluid to be delivered to the well head 26. For example, and not by way of limitation, the blender 20 may be operably connected to a suitable supply of water 18 (fresh, produced, or a blend), acid 16, and/or other chemicals 17.

A manifold 22 may be used to distribute or pump a fracturing fluid to a well head 26. A manifold 22 may be a frac manifold 22 that may include an arrangement of flow fittings and valves installed downstream of the frac pump output header and upstream of each frac tree being served. Any manifold 22 suitable for the intended purpose may be utilized in an appropriate configuration.

A frac van 24, or frac truck 24, may be used to monitor, display, and control the hydraulic fracturing equipment and process. The frac van 24 may be operably connected to all the other equipment used in the hydraulic fracturing process, including without limitation, the sand storage 12, the sand conveyor 14, the blender 20 and its accompanying water 18, acid 16, and chemical 17 materials, and the manifold 22. The frac van 24 may include a monitoring system, a display system, and a control system that enables engineers and/or crew members to monitor and control the fracturing process from the frac van 24. The frac van 24 may include a frac control system that can monitor, display, and control the hydraulic fracturing equipment and processes at a well-site.

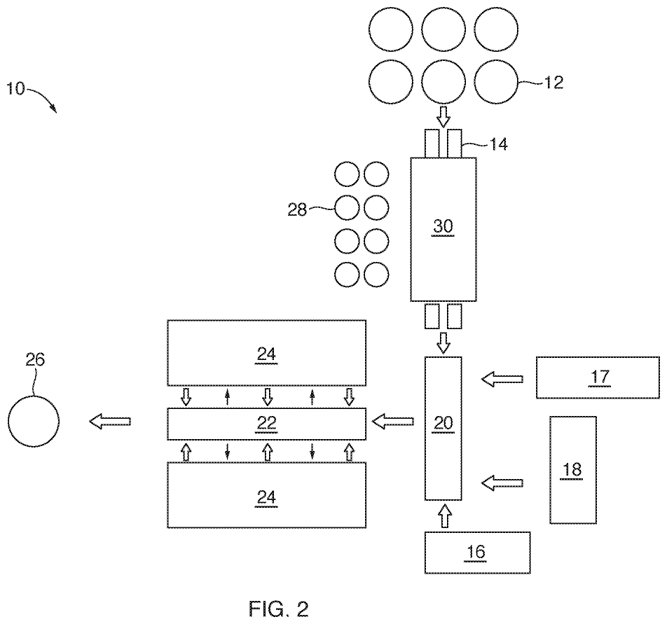

Referring to FIG. 2, a mobile coating unit 30 may be placed between sand storage 12 and a blender 20. The mobile coating unit may be positioned along or in the path from the sand storage 12 to the blender 20 in a manner that utilizes the sand conveyor 14 to transport sand from the sand storage 12, through the mobile coating unit 30, and then to the blender 20. Depending on space available at a well-site, a mobile coating unit 30 may be positioned at a suitable angle. The placement of the mobile coating unit 30 may be adjusted to the needs of a specific well-site.

The mobile coating unit 30 may be described as having a proximal end and a distal end. The sand or proppant from the sand storage 12 may be transported along the sand conveyor 14 to the proximal end of the mobile coating unit 30 where it may be deposited into a charge hopper 34 on the mobile coating unit 30. The sand then goes through the coating process and exits the mobile coating unit 30 at its distal end. As the coated proppant, or coated sand, exits the mobile coating unit's distal end, the coated proppant may be deposited into the blender 20, or the sand conveyor 14 may be used to transport the coated proppant to the blender 20.

The mobile coating unit 30 may be operably connected to coating additives 28. The coating additives 28 may include any suitable type of additive (i.e., friction reducers, biocides, breakers, viscosifiers, scale inhibitors, etc.), and the additive may be in any desired form (i.e., liquid or powder). The coating additives 28 are connected to appropriate structures on the mobile coating unit 30. For example, liquid coating additives may be stored in any suitable storage mechanism including, but not limited to, a hopper, a tank, a tote, a chemical transport vehicle or silo, and connected to a liquid additive dispenser 40, or sprayer 40. Similarly, powder coating additives may be stored in any suitable storage mechanism including, but not limited to, a hopper, a bulk bag, pneumatic tank, chemical transport vehicle or silo, and connected to a volumetric powder dispenser 60 that dispenses either by volume or weight.

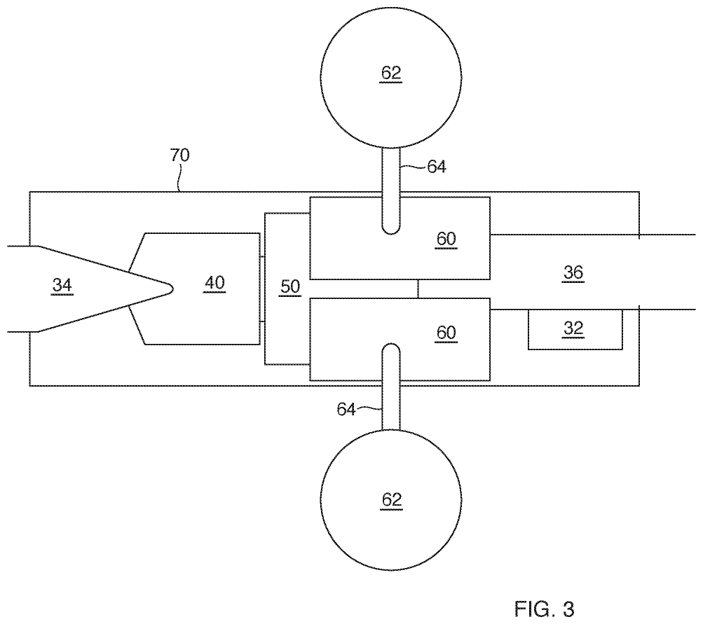

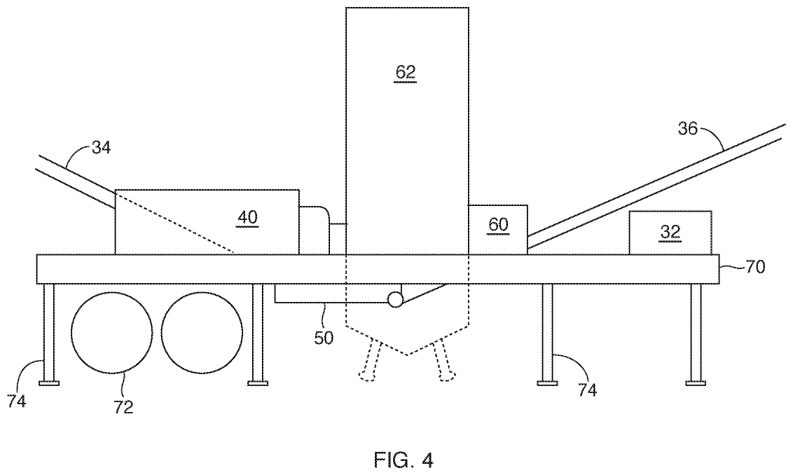

Referring to FIGS. 3 and 4, a mobile coating unit 30 may be comprised of multiple structures and equipment to provide the ability to coat proppant, or sand, at a well-site. A suitable platform 70, or trailer 70, may be used to support and transport the equipment that comprises the mobile coating unit 30. A platform 70 may be made of any suitable material and may have any suitable size and dimensions, as long as it can properly support the mobile coating unit 30 and its associated equipment, and of course, be mobile and transportable. A platform may be suitably connected to a chassis with wheels 72, or skids (not shown), so that the mobile coating unit 30 can be transported to a well-site. A platform 70 may include one or more supports 74 that can provide additional stability to the mobile coating unit 30 when the mobile coating unit 30 is functioning at a well-site, but the supports 74 may be removable or retractable when the mobile coating unit 30 is being transported. Being either skid or trailer mounted means that a mobile coating unit 30 can be located onsite at the well, or at a sand mine, providing flexibility to leverage economic considerations, space availability, and throughput demands.

Generally, a mobile coating unit 30 will include at least a PLC control unit 32, a liquid additive dispenser 40, a volumetric powder dispenser 60, and a coating blender 50, or coating mixer 50. Other structures may be included with a mobile coating unit 30 or may be at a well-site and usable by the mobile coating unit 30. The structures associated with a given mobile coating unit 30 may be distributed in any effective manner so as to allow for sufficient space to house all parts and to enable efficient processing by the individual unit structures. The unit structures may be self-contained and/or protected from the weather, if needed.

For example, an inbound sand storage unit 34, or a charge hopper 34, may store sand received from the well-site's sand storage 12 prior to the sand's use in the mobile coating unit 30. Similarly, an outbound sand belt 36 may be used to transport resultant, coated proppant, or coated sand, from the mobile coating unit 30 to a blender 20, or to another section of a sand conveyor 14 and then to a blender 20.

A mobile coating unit 30 may be operably connected to one or more powder additive silos 62 where the powder additive is transported to the mobile coating unit 30 via one or more powder additives conveyors 64. The primary purpose of the powder additive silos 62 may be to keep the volumetric powder dispenser 60 full of available powder additives.

A mobile coating unit 30 may include a dryer at most any stage to dry the proppant, or remove excess moisture from the proppant. A mobile coating unit 30 may be configured to accept and successfully coat a variety of proppants, like wet sand, dry sand, ceramic proppant, resin-coated proppant, wet fibers, dry fibers, etc. A mobile coating unit 30 may include some or all of these equipment components depending on the desired design and intended functionality.

A typical process for using a mobile coating unit 30 to coat sand, ceramic, resin, fibers, or another proppant at a well-site may be described as follows. First, it should be understood that the PLC control unit 32 is operably connected to the other equipment components of the mobile coating unit 30 in a manner that allows the PLC control unit 32 to monitor and control the unit's coating processes. Such operable connections may be described as including electronic and physical connections in that the PLC control unit 32 can monitor and control the amount of proppant moving through the mobile coating unit 30 and control the amount and timing of coating additives 28 used. The PLC control unit 32 may be pre-programmed with any desirable formulas or recipes for coated proppants and can provide the formula or recipe and the order of process needed to produce the desired coated proppant product. It can also be initiated to run as a stand-alone, be triggered by inputs from an outside source, such as a frac van 24, or remotely controlled.

It should also be understood that the PLC control unit 32 may be operably connected to the control system of the well-site's frac van 24, so that the engineers in the frac van 24, or those remotely monitoring and controlling the job, can control the hydraulic fracturing process normally associated with the well-site (i.e., monitoring and controlling the sand conveyor 14, the blender 20, the manifold 22, etc.), as well as controlling the coating processes on the mobile coating unit 30 (i.e., the liquid additive dispenser(s) 40, the volumetric powder dispenser(s) 60, the coating mixer 50, etc.).

The PLC control unit 32 can include one or more programs that the control unit 32 uses to control the mobile coating unit 30 and produce a desired, coated proppant. These programs may be described as formulas or recipes for producing a desired coated proppant. A formula or recipe can provide for a very wide range of coated proppants that may be produced by the mobile coating unit 30, limited only by the number of additives 28 available to the unit 30. For example and not by way of limitation, the mobile coating unit 30 may be used to produce a coated proppant that has only a liquid coating, or only a powder coating, or multiples and combinations of either type of coating. A formula may also be adjusted depending on the proppant being used, dry sand, wet sand, fibers, or the like. Also, different formulas or recipes may be utilized during different stages of a hydraulic fracturing process.

The PLC control unit 32 on the mobile coating unit 30 is the monitor and controller of the coated sand process. It can follow pre-programmed recipes that are driven by a belt-scale on which the sand is moved from the charge hopper 34, or surge hopper 34, on the mobile coating unit 30 into the coating section of the unit. Based on that weight, the PLC control unit 32 instructs the feeders of all the other inputs (i.e., liquid additive dispenser(s) 40 and volumetric powder dispenser(s) 60) how much additive to dose, and it can do this in real-time at the well-site. The engineer or user may select the coated sand from the pre-programmed options, or the engineer could make alterations to the recipe by increasing one or more of the individual inputs. For example, the system could be programmed to make an appropriate addition of tackifier if the polymer loading increased.

The coating section of the mobile coating unit 30 may function as a continuous flow set-up where coated proppant product can exit the coating section of the unit 30 and proceed toward the blender 20 on a belt that is already part of any standard, current well-site configuration. The operational specifications of the mobile coating unit 30 may be adjusted to accommodate desired throughputs.

A mobile coating unit 30 may be part of a “frac fleet” that would be servicing the wells of a single operator company. That operator company may have the capability to utilize either wet or dry sand, but usually not both. That operator company may have a philosophical bent, or preference, toward wet or dry sand. The pre-programmed recipe on the mobile coating unit 30 may account for the condition of the sand, either wet or dry. Also, either type of recipe could utilize both liquid and/or powdered additives as desired. While a mobile coating unit 30 may be capable of accommodating wet and/or dry proppants, it may be programmed to utilize one or the other. While unlikely, a mobile coating unit 30 may be configured and programmed to accommodate wet and/or dry proppants at a given well-site. Similarly, a mobile coating unit 30 may be configured and programmed to accommodate or use fresh and/or produced water, or a mix thereof, at a given well-site, if necessary. For example, a liquid additive dispenser 40 may be configured to use fresh and/or produced water as a portion of a liquid additive, such as a tackifier.

At times, the mobile coating unit 30 may not treat or coat proppant going through the unit 30 at all. For example, if just proppant, or sand, is desired to be delivered from the sand storage 12 to the blender 20, the mobile coating unit 30 may act effectively as a conveyor of the proppant, without the addition of any additives 28.

Any suitable proppant, like sand or fibers, can be deposited in the sand storage unit 34, or the charge hopper 34, at the proximal end of the mobile coating unit 30. The proppant may then be conveyed or moved through a liquid additive dispenser 40, or sprayer 40. The charge hopper 34 may have a belt with a weigh scale that moves the sand at a specific rate and volume into the coating mixer 50. Prior to the sand being deposited into the coating mixer 50, the sand is exposed to a liquid additive that is being sprayed in as the sand drops into the coating mixer 50.

Typically, a liquid additive dispenser 40 will include sprayers that spray a pre-determined amount of a selected liquid additive onto the proppant as the proppant proceeds through the liquid additive dispenser 40 and/or as the proppant drops into the coating mixer 50. Any equipment suitable to perform this function as part of a mobile coating unit 30 at a well-site may be utilized accordingly. For example, produced water may be utilized as part of a tackifier mixture that is sprayed onto the proppant, or for any other suitable purpose. A liquid additive dispenser 40 may include temperature controls to maintain the liquid additive at a desired temperature. A temperature-controlled tank may be used to create uniform blends of a variety of chemical fluids and dispense these fluids uniformly through a misting exit system, optimally introducing the fluids into a mixing process. The PLC control unit 32 may monitor and/or control the factors necessary to provide the desired liquid coated proppant that will exit the liquid additive dispenser 40. For example, the PLC control unit 32 may monitor the amount of sand entering the liquid additive dispenser 40 and the rate of entry of proppant to determine how much of a liquid additive needs to be dispensed or sprayed onto the proppant. Also, one or more liquid additives may be sprayed onto the proppant as determined by the PLC control unit 32. A liquid additive dispenser 40 may be described primarily as a component that dispenses or sprays a liquid additive onto a proppant. Equipment for storing and/or mixing liquid additives may or may not be part of the liquid additive dispenser 40 itself, or the mobile coating unit 30. For example, a truck could be used to provide one or more liquid additives to the liquid additive dispenser 40, or the liquid additive dispenser 40 could be operably connected to a source of liquid additives that is already at a well-site, like friction reducer or the like.

As a proppant exits the liquid additive dispenser 40, it is generally deposited into a coating mixer 50. There may be approximately 7-10 seconds before a desired powder additive is dispensed into the coating mixer 50 by a volumetric powder dispenser 60. The type of powder additive and the dispensed amounts are predetermined by the formula or recipe selected by an engineer and controlled by the PLC control unit 32. A mobile coating unit 30 may include one or more volumetric powder dispensers 60. All the ingredients are coated for a predetermined residence time in the coating mixer 50. A typical residence time is approximately five (5) to fifteen (15) seconds. The resultant coated proppant may then be fed out to the blender 20 by the out-bound sand conveyor 36.

A volumetric powder dispenser 60 may be created to handle product at a variety of mesh sizes, the powder mixer uniformly blends a variety of dry powder additives to create a fine proprietary powder mixture that is introduced into the coating process through a time initiated dispensing unit.

Volumetric powder dispensers 60 may be kept full by the powder additive silos 62 and the powder additive conveyors 64, which serve only that purpose. The powdered additive may be obtained from a powder additive silo 62, or any other suitable container. The powdered additive may be delivered to the volumetric powder dispenser 60 by a powder additive conveyor 64 operably connected to convey a powder additive from a powder additive silo 62 to the dispenser 60. The dispenser 60 may add the powdered additive to the proppant in any suitable manner, including without limitation, dumping, sprinkling, shaking, or the like. One or more powder additives may be added to the proppant by the dispenser 60 in a manner as described. The PLC control unit 32 may monitor and/or control the factors necessary to provide the desired powder coated proppant that will exit the coating mixer 50. For example, the PLC control unit 32 may monitor the amount of sand entering the coating mixer 50 and the rate of entry of proppant to determine how much of a powder additive needs to be dispensed or added to the proppant. Similarly, the PLC control unit 32 may monitor and control the amount of powder additive that is moved to the dispenser 60 from a powder additive silo 62, for example, by using a belt-scale type powder additive conveyor 64. A volumetric powder dispenser 60 may be described primarily as a component that dispenses a powder additive onto a proppant. Equipment for storing and/or mixing powder additives may or may not be part of the volumetric powder dispenser 60 itself, or part of the mobile coating unit 30. For example, a truck or box could be used to provide one or more powder additives to the volumetric powder dispenser 60, or the volumetric powder dispenser 60 could be operably connected to a source of powder additive that is already at a well-site.

The coating mixer 50 may be any equipment suitable for mixing or blending the coated proppant mixture, for example, a coating mixer 50 may be described as a twin shaft blender, or twin shaft ribbon blender, or a ribbon blender with paddles attached to the ribbon at appropriate intervals, or the like. A coating mixer 50 may be used for the surface activation process and the surface layering process. It may possess the standard ribbon, as found generally in similar blending units, or it may differ due to custom added paddles that are positioned at specific locations to enhance the performance and efficacy of both. Any coating mixer 50 capable of performing the desired function, mixing or blending the coated proppant mixture, may be utilized.

Generally, the individual ingredients or constituents of a coated proppant product may spend approximately 15 seconds in the mixer 50, which may be described as a residence time, before the coated proppant product is transported to the blender 20. A residence time may be adjusted depending on the additives 28 used to produce the coated proppant, the needs of the well-site, and/or similar factors. A residence time may range from approximately 5 seconds to approximately 5 minutes.

After a coated proppant product is completed and exits the coating mixer 50, the time between the coating of the proppant and the delivery of the coated proppant product to a well head 26 can vary significantly depending on certain factors, and may include any time less than ten (10) days after the coating of the proppant. This range of delivery time may be adjusted depending on the specific coated proppant product, the needs of the well-site, the desire to address real-time situations, and/or similar factors. This range of delivery time may also accommodate work stoppages at the well-site that can occur for any number of reasons. For example, if the well-site is functioning as intended, the coated proppant product may be delivered to a well head in less than 1 minute of the coating of the proppant. If the well-site is experiencing some delay or difficulty, the delivery time could be longer and depend greatly on when operations can resume.

The coating mixer 50, and other transport structures associated with the mobile coating unit 30, can be designed and implemented to accommodate the relatively high, real-time throughput demands of a well-site. A single mobile coating unit 30 may be configured to provide a throughput of approximately 450 tons per hour, or within a range of approximately 250 tons per hour to 600 tons per hour. A mobile coating unit 30 may be configured in a variety of ways and include a variety of equipment components to meet the demands of a specific well-site, or the preferences of a specific operator company.

As a whole, a mobile coating unit 30 can be configured to provide a throughput of coated proppant similar to that of a fixed location plant, but without the significant costs and lack of flexibility of such plants. A fixed location plant may run at a less than optimum throughput rate, which means the plant is under-utilized. Running a fixed location plant at more than optimum rates may cause stress to the equipment, or is simply not possible. A mobile coating unit 30 may have a range of possible throughputs. If additional throughput is needed, two or more mobile coating units 30 could be added to a well-site to obtain the desired throughput without significantly increasing the operational footprint at the well-site.

Moreover, a properly functional mobile coating unit 30 can be configured to occupy significantly less space, which is highly advantageous both at a sand mine and at well-sites. A relatively small, mobile unit is less likely to interrupt or impede traffic and the other operations at a sand mine or well-site. A mobile coating unit 30 may have an approximate size of 40 feet by 9 feet, so that it can be strategically placed, moved a few feet without significant interruption to the unit 30, or even moved off-site if desired.

Various, alternative configurations may be utilized for the mobile coating unit 30 that can add to its functionality as desired for a given well-site. For example, a dryer may be used at most any stage of the coating process to dry the proppant, or remove excess moisture. A dryer may be included so that the proppant is dried before it enters the liquid additive dispenser 40, or before it enters the coating mixer 50. This would be useful if wet proppant at a well-site needed to be dried prior to use by the unit 30, or if very dry proppant is desired for a given formula or recipe to produce a given coated proppant. A dryer may be included after the liquid additive dispenser 40 to dry the liquid coated proppant if that is desirable before that proppant moves on in the process. A dryer may be included with the coating mixer 50 if it is desirable to dry the coated proppant during mixing. Similarly, a dryer may be beneficial at various stages depending on the proppant, wet sand, dry sand, fibers, etc. These examples are not provided as limiting examples, but as illustrative or various possible configurations.

In one embodiment, a mobile coating unit 30 may receive all necessary information from a well-site frac van 24. The unit 30 may then utilize an integral algorithm to translate the received information into the type of coating needed and the rate of coating necessary to produce the custom coated proppant on the well-site as needed in real-time. The type of coating needed and the rate of coating necessary to produce the custom coated proppant may be adjustable during the fracturing operation based on the real-time information received from the frac van 24.

In one embodiment, the mobile coating unit 30 may know the distance to the sand storage and based on the given rate knows how long until it will take to receive proppant, or substrate, and at which point it will need to initiate its coating process. The finished, coated proppant product can come out of the mobile coating unit 30 and feed directly into the well-site blender 20, which then functions as usual. The timing added to complete the custom coating process may be automatically calculated by the PLC control unit 32 and allows the frac van 24 to know at which specific time the blender 20 will begin churning.

Proppant may arrive at a well-site by any suitable mechanism, i.e., pneumatic truck or box, and be off-loaded into the on-site sand storage silos/boxes. Proppant may leave these silos/boxes at an appropriate rate to keep the charge hopper 34 on the mobile coating unit 30 full. The proppant may enter the hopper on the mobile coating unit 30 and be metered out at an appropriate rate to achieve the desired sand loading in the fracturing fluid based on the fracturing design. The proppant may be coated with the chemicals or additives 28 as prescribed by the fracturing design with any necessary alterations to the design being made and informed by information from the frac van 24, or data van 24. The selected coated proppant may exit the mobile coating unit 30 and be transported to the well-site blender 20, or deposited directly from the coating unit 30 into the blender 20, where it could be mixed and pumped down-hole.

There may exist connectivity between the frac van 24, the mobile coating unit 30, and the on-site silos/boxes 12. The fracturing design may be programmed into the frac van 24 system, and usually already is before the frac van 24 is operably connected to the mobile coating unit 30. The frac van 24 could communicate with the mobile coating unit 30 to instruct the coating unit hopper 34 to release enough sand to be processed in the coating unit 30 to keep up with the frac design, where typical rates for dispensing sand may vary from about 100 to about 350 TPH (tons per hour). The mobile coating unit 30 may communicate with the on-site sand storage silos/boxes 12 to make sure that the charge hopper 34 is kept full. Based on information the frac van 24 is processing about the down-hole conditions, the frac van 24 can communicate with the feeders that are on the mobile coating unit 30 (i.e., the liquid additive dispenser 40 and the volumetric powder dispenser 60) to determine what chemicals or additives 28, in what quantities, will comprise the coating for the coated proppant being produced at that particular time. The coated proppant may exit the mobile coating unit 30 at an appropriate rate and be transported to the blender 20. A coated proppant can be produced in the mobile coating unit 30, transported to the blender 20, and pumped into a well head 26 all within approximately 10-20 seconds, or within a range of approximately ten (10) seconds to approximately three (3) hours, or even within ten (10) days.

The formula or recipe for a desired coating can be changed based on real-time, down-hole conditions being monitored by the frac van 24. Thus, the mobile coating unit 30 can produce a first coated proppant at one time and then change to produce a second, separate coated proppant at another time. Such changes can be made to address the real-time changes to conditions down-hole throughout the hydraulic fracturing process.

The use of coated proppants in a fracturing fluid can provide multiple benefits. The various types of available coating additives 28 makes coated proppant products an effective way in which down-hole conditions can be modified to assist in the well completion process.

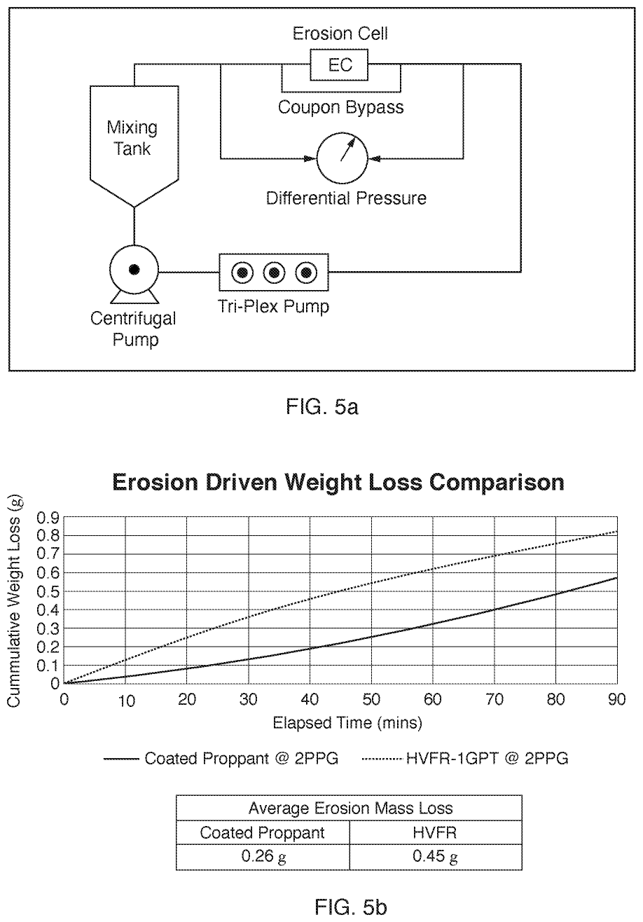

Referring to FIG. 5a, the diagram illustrates a testing procedure for determining erosion driven weight loss for a proppant. For the testing procedure, a stainless-steel coupon was weighed, and its initial weight was recorded. The diameter of the opening of the insert was measured and recorded. The steel coupon was placed into the erosion cell and the blender was filled with 75 gallons of water along with 150 pounds of uncoated sand. The proppant laden fluid was then flowed through the system via the triplex pump at 57-60 gpm. Every 30 minutes the stainless-steel coupon was taken out of the erosion cell and the weight recorded. During the time the steel coupon insert was taken out of the erosion cell, the fluid was bypassed and continued through the flow loop. This testing procedure was performed in accordance with Pressure Testing Research Cooperative™ guidelines.

Referring to FIG. 5b, the graph shows the results of the erosion driven weight loss comparison. As observed, there was a substantial reduction in erosion of the environments as a result of using a self-suspending coated proppant as compared to a common, industry-used method. The coated proppant is an hydrophilic linear polyacrylamide (not cross-linked) coated proppant as compared to a high-viscosity friction reducer based system.

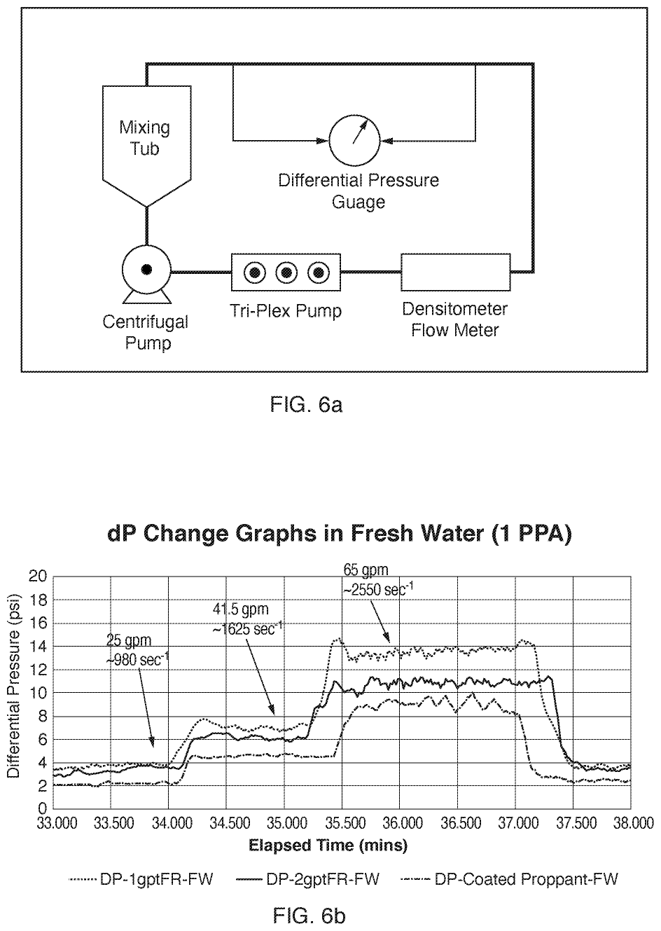

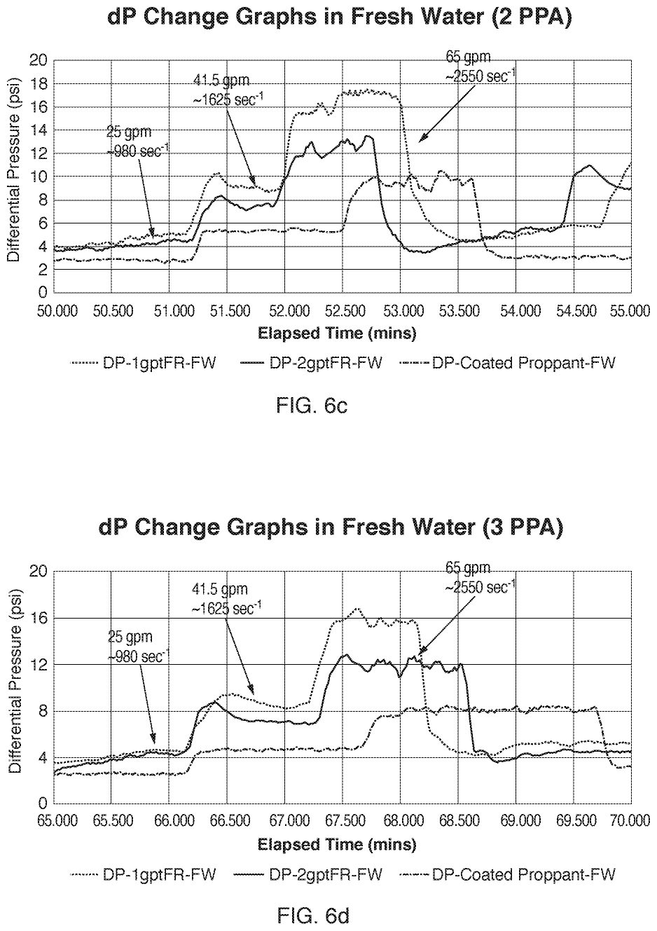

Referring to FIG. 6a, the diagram illustrates a testing procedure for evaluating the effects of certain products on pumping pressures. For the testing procedure using a high-viscosity friction reducer, a high-viscosity friction reducer is added to water in a mixing tub. Fluids are pumped at 25, 41.5, and 65 gpm. Proppant is added at 0.5, 1.0, 2.0, and 3.0 PPA performing pump rate changes and recording dP before proceeding to next proppant concentration. The slurry is dumped and the next polymer concentration is mixed. These steps are repeated as necessary. For the testing procedure using an hydrophilic linear polyacrylamide (not cross-linked) coated proppant, the coated proppant is added at 0.5, 1.0, 2.0, and 3.0 PPA performing pump rate changes and recording dP before proceeding to the next proppant concentration. The slurry is dumped and the next polymer concentration is mixed. These steps are repeated as necessary. This testing procedure was performed in accordance with Pressure Testing Research Cooperative™ guidelines.

Referring to FIGS. 6b-6d, the graphs show the results of the effects on pumping pressures. As observed, the use of the coated proppant helps to reduce pumping pressures as compared to commonly used industry products.

The use of an hydrophilic linear polyacrylamide (not cross-linked) coated proppant was also evaluated in a tortuous path test, as compared with common industry-used products. A tortuous path was designed having a column with an height of 4 feet, a length of 8 feet, a constant width throughout, and two flow path changes within the column.

First, the behavior of frac sand with slickwater (a common type of fracturing fluid) was evaluated. It was determined that frac sands pumped with slickwater will create a defined, recycle zone by the inlet, causing much of the last proppant entering the wall to settle close to the inlet. Both sands, despite the sequence, established significant dunes in the first half of structure. How quickly the dune peak formed was dependent upon the order of the proppant. Tailing-in with 40/70 established a larger dune, closer to the inlet. This is possible due to coarser grains not being able to travel over dune peak. Tailing-in with 100 mesh allowed the proppant to travel to the end of the structure and ultimately to place more proppant in the effluent tanks. The finer particles of the 100 mesh could better travel over the dune peak and into the effluent tanks.

The behavior of frac sand with increased viscosity, 2.5 gpt HVFR and 4.0 gpt HVFR, was also evaluated. Proppant transport was much improved with 2.5 gpt HVFR as compared to slickwater. There was immediate proppant suspension upon entering the wall with quick settlement. Twice the amount of proppant traveled to the effluent tank with the increased viscosity (2.5 gpt HVFR). Unlike slickwater, most of the proppant efficiently traveled over the dune/bed as it entered the wall, allowing the last proppant to enter the cell to move away from the inlet/wellbore. When increasing the fluid viscosity to 2.5 HVFR with 100 mesh, the dune peak was eliminated. When pumping 2.5 HVFR with 40/70, a dune peak was still established.

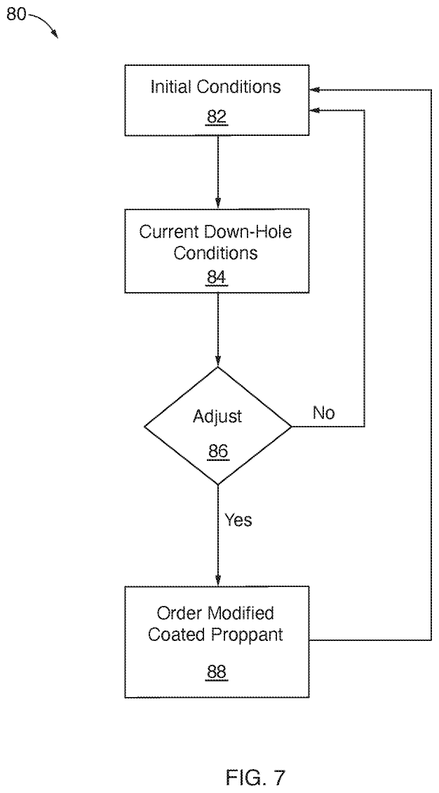

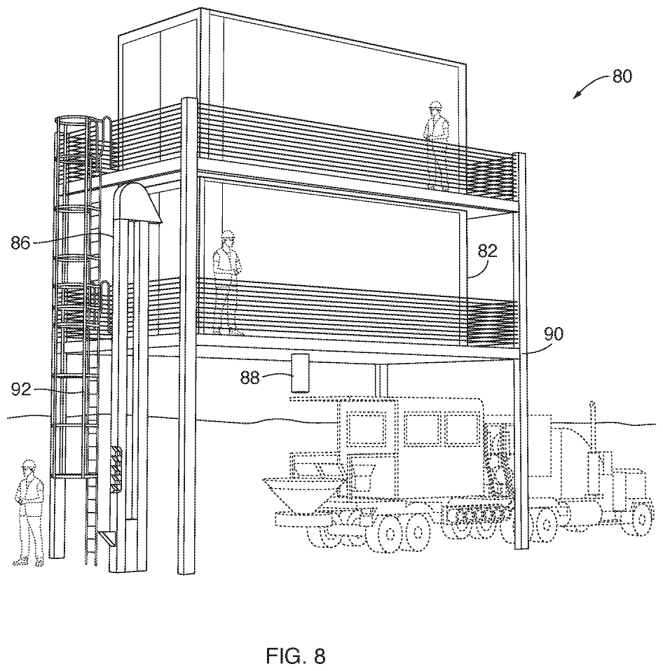

Referring to FIG. 7, an evaluation process 80, or evaluation 80, is described that may be performed at a well-site to determine whether an adjustment to the hydraulic fracturing process, the fracturing fluid, or the coated proppant is advisable. While there are numerous adjustments that can be made during an hydraulic fracturing process, this example describes primarily possible changes to a coated proppant product used in the fracturing fluid.

The initial conditions 82 of the well-site may include a number of factors, including but not limited to, the frac design or frac plan for the particular site, the available equipment, etc. The initial conditions 82 may also be described as a starting point for the monitoring process. A frac van 24 may be set up to include, monitor and display all necessary information regarding initial conditions 82.

The current down-hole conditions 84 of the well-site may be monitored by a frac van 24 and its control system. The frac van 24 may monitor a number of down-hole conditions, or parameters, including but not limited to: total sand, or pounds of sand used per stage; sand loading, or pounds of sand per gallon of fracturing fluid (“PPG”); sand ramp schedule, which describes the steady, incremental increase in sand loading (i.e., 0.5 lbs./gallon for 10 tons, 0.75 lbs./gallon for 7 tons, 1.0 lbs./gallon for 10 tons, etc.); total fluid, or barrels (“BBLS”); pump rate, or barrels per minute (“BPM”); maximum pressure, or psi—determined by the equipment (i.e., pipe, stack, etc.); friction reducer concentration, which can be described as gallons of friction reducer per 1000 gallons of fracturing fluid (“GPT”) if a liquid friction reducer is used, or pounds of friction reducer per 1000 gallons of fracturing fluid (“PPT”) if a powder friction reducer is used; other chemical loadings, including biocides, scale inhibitors, surfactants, buffers, etc., which can described in GPT or PPT as applicable; and water quality, or parts per million (“PPM”) chlorides and other certain divalent ions.

Generally, an engineer, or an engineering crew, in a frac van 24 may monitor all necessary parameters via a display screen that tracks or plots the parameters in real-time, using multiple lines (usually of different colors) to illustrate the progress of the fracturing process while displaying the status of the various parameters. The primary monitored conditions or parameters in the frac van 24 are usually pressure, friction reducer concentration, pump rate, and sand loading.

Based on this evaluation 80 and monitoring process, an engineer may come to a point where a decision must be made regarding a possible adjustment 86 in the fracturing process. Certain changes or fluctuations in the down-hole parameters are to be expected and may not require any changes, nor suggest the use of a different coated proppant to change the down-hole conditions. If no adjustment is necessary or desired, the evaluation 80 and monitoring process may simply continue as before. However, certain changes or fluctuations in the down-hole conditions may warrant, or even necessitate, a change in the coated proppant to effect a change in the down-hole conditions.

An engineer may order a modified coated proppant product 88. The engineer may send a signal to the PLC control unit 32 on the mobile coating unit 30 with instructions regarding a specific coated proppant the engineer would like added to the fracturing fluid. Such a modified coated proppant can be a coated proppant product that is significantly different from a coated proppant currently being used by the system. For example, the engineer could switch from using a coated proppant with a friction reducer coating to a coated proppant with a breaker coating. Based on real-time data from the frac van 24, a modified coated proppant may also result in using more or less of a coating. For example, the engineer could switch from a coated proppant with a high level of friction reducer to a coated proppant with a lower level of friction reducer. The engineer can also utilize coated proppant products that have multiple coatings at different levels. The variations of coated proppant products available to the engineer may be virtually limitless.

Thus, the engineer can address almost any down-hole condition with an appropriate coated proppant and deliver that coated proppant to the well head 26 within minutes of noticing the situation. After any changes or adjustments are made, the evaluation process 80 can continue as before.

In one embodiment, an artificial intelligence unit can be used to monitor and control the evaluation process 80 described. An artificial intelligence unit may be programmed to machine learn the evaluation process 80, including analyzing the frac design, monitoring the down-hole conditions, and making adjustments according to a pre-determined set of parameter changes, or in accordance with its own learning. For example, artificial intelligence or inferencing may be used to create decision trees based on past experiences with hydraulic fracturing, or engineer inputs. An artificial intelligence unit may be pre-programmed with decision trees based on previous experiences with hydraulic fracturing processes and fluctuations in the down-hole conditions. An artificial intelligence unit may also learn from onsite engineer responses. An artificial intelligence unit may be programmed to assist onsite engineers, or to virtually control the evaluation process 80 described herein.

As mentioned previously, a “frac design” or “frac plan” is usually developed for a specific well-site. The development of a frac design is a detailed and time consuming process. Extensive analysis is conducted on existing wells within a reasonable geographic area. The comparison and/or contrast may narrow by basin and formation, so that information regarding what has worked or not worked before can be utilized to maximize the return on investment an operator company can realize from each well.

Completion and Reservoir Engineers evaluate the available data and perform the necessary analysis to develop of frac design for a given well. That frac design usually splits the completion process into separate “stages,” and a modern frac design may include sixty or more such stages. Each stage will have a PAD phase that is only liquid. The purpose of the PAD is to initiate the fractures. After the PAD, the completion crew begins to add sand and/or proppant to the liquid. The amount of sand is slowly ramped up according to a schedule that is followed until the desired amount of sand for that stage is placed. To complete a stage, a “flush” is generally pumped. The flush is only liquid and is primarily intended to remove any excess sand from the well-bore.

A typical frac design may be based on multiple parameters. For example, and not by way of limitation, relative parameters evaluated in a frac design may include the following: total sand, or pounds of sand used per stage; sand loading, or pounds of sand per gallon of fracturing fluid (“PPG”); sand ramp schedule, which describes the steady, incremental increase in sand loading (i.e., 0.5 lbs./gallon for 10 tons, 0.75 lbs./gallon for 7 tons, 1.0 lbs./gallon for 10 tons, etc.); total fluid, or barrels (“BBLS”); pump rate, or barrels per minute (“BPM”); maximum pressure, or psi—determined by the equipment (i.e., pipe, stack, etc.); friction reducer concentration, which can be described as gallons of friction reducer per 1000 gallons of fracturing fluid (“GPT”) if a liquid friction reducer is used, or pounds of friction reducer per 1000 gallons of fracturing fluid (“PPT”) if a powder friction reducer is used; other chemical loadings, including biocides, scale inhibitors, surfactants, buffers, etc., which can described in GPT or PPT as applicable; and water quality, or parts per million (“PPM”) chlorides and other certain divalent ions.

These parameters are assessed and established leading into the “completion” process. Based on the frac design for the completion, an operator company may select a desired coated proppant as the “base product” to be utilized and pumped in the established frac design.

The PLC control unit 32 is the “brain” of the mobile coating unit 30 and connects to the sand, tackifier, friction reducer (“FR”) and other chemical feeders. The recipe for this “base product” design resides in the PLC control unit 32 on the coating unit 30, along with any other “standard” product recipes that the operator company may use.

As a stage begins, and sand is required, it is transported from the silos 12 that exist on-site (part of every frac site), along a belt 14, and is deposited in a charge hopper 34 on the mobile coating unit 30. Sand exits the charge hopper 34 on a belt-scale. The weight of sand measured by the belt-scale allows the PLC control unit 32 to correctly communicate with the other feeders and calculate the appropriate additions of tackifier, FR and other chemicals to create the “base product.”

The frac van 24, or frac truck 24, is the brain of a well-site. The frac van 24 on current well-sites controls the on-site sand silos 12, the belts 14 that carry sand out of the silos toward the blender 20, the blender itself, and other on-site equipment. The primary monitored parameters in the frac van 24 are pressure, friction reducer concentration, pump rate, and sand loading. Pressure is the primary driver of friction reducer. The other additives generally remain fixed and under most circumstances changes in the additions of those additives would only be to keep them proportionate and entering the system in the correct amounts.

In one embodiment of the current invention, the mobile coating unit 30 plugs in between the on-site sand silos 12 and the blender 20. The PLC 32 on the mobile coating unit 30 is connected to, and controlled by, the frac van 24. Inside the frac van 24, an engineer and sometimes frac consultants, diligently monitor a screen that provides real-time readings of several parameters, including at least the following: total sand, sand loading, pump rate, pressure, and friction reducer concentration.

If the stage is running smoothly, the frac design runs as planned and the mobile coating unit 30 may produce the base product in the amounts required to fulfill the frac design. If the stage is not running smoothly, as is often the case, the mobile coating unit 30 can make adjustments and produce a specified coated proppant that help to better fulfill the frac design despite changes in planned conditions.

While ensuring that the frac design is being followed, one of the primary concerns in the frac van 24 is the pressure reading. The pressure reading is an indicator of several things. Generally, the pressure reading is an indicator of how well the formation is taking the sand. This is important because one of the most costly and time wasting events that can happen during a completion stage is called a “screen out.” A “screen out” means that sand is not passing through the perforations in the casing and into the fractures, leaving sand in the well-bore. In the event of a “screen out,” the entire job can be down for many hours and a coil tubing unit must be brought in to clear the sand. Depending on where in the completion the “screen out” occurs, the cost of remedying the “screen out” can be significant (i.e., approximately $100,000 or more).

If the pressure reading begins to approach the maximum pressure threshold, the engineer makes an assessment and decides what change or changes need to be made. Usually, the first thing done is to add friction reducer.

In one embodiment of the current invention, such adjustments may be accomplished by the engineer in the frac van 24 communicating to the PLC control unit 32 of the mobile coating unit 30 that the friction reducer portion of the coating needs to be increased by a certain, designated percentage. Upon receiving that message, the PLC control unit 32 would communicate with the friction reducer feeder and make the necessary increase in friction reducer addition, which is based on the belt-scale reading of sand being utilized at that given time, as dictated by the frac design.

A likely second adjustment would be to cut or lower the pump rate. As above, this adjustment would create real-time changes in the recipe. Cutting or lowering the pump rate would dictate that less sand would be demanded in the same amount of time, even at the same sand loading. Therefore, the communication from the engineer in the frac van 24 to the PLC control unit 32 cutting the pump rate would slow down the sand flow, which in turn would decrease the tackifier, friction reducer and other chemical additions going into the mobile coating unit 30, while maintaining the integrity of the recipe.

A final adjustment would be to reduce the sand loading. Once again, this communication by the engineer from the frac van 24 to the PLC control unit 32 would cause adjustments in the sand demand that would create real-time adjustments to the tackifier, friction reducer, and other chemical feeders.

As already described, a mobile coating unit 30 may be designed and configured to make modifiable coated proppant at a well-site and adjustable in real-time based on down-hole conditions at the well-site.

In certain instances, even when a stage is proceeding as planned, the engineer may be able to make changes that are not responsive to a problem, but rather to be more aggressive in the completion process, possibly saving time and costs. One of the possible adjustments may be to the pump rate. The engineer may adjust the pump rate because the formation is very accepting of sand. In this case, the same adjustment process would take place. The engineer would communicate from the frac van 24 to the PLC control unit 32 to increase the rate, and the PLC control unit 32 would make the adjustments to the amount of sand entering the system, which in turn would adjust the feeders for the other input products.

In another embodiment of the invention, the data from the frac van 24 is captured, logged, and stored to facilitate “machine learning.” Particularly, the capturing software would be programmed to “learn” what specific, real-time factors, as viewed by the engineer in the frac van 24, led the engineer to alter the coating, and what alterations were made. After a satisfactory amount of data is captured, logged, and analyzed, the frac van 24 controls could be driven by programming developed from the “machine learning,” making real-time adjustments to the coating based on comparing current actual data to the programmed instructions, ranges, and limits. The frac van controller communicates the necessary changes to the PLC control unit 32 to adjust the recipe in the same manner as described in the previous embodiment. The frac crew member responsible for the frac van controls is there to address major issues or problems that fall outside the programmed instructions or parameters.

Utilizing “machine learning” in this manner would be an improvement over current systems for multiple reasons. The on-site engineers at the controls of the frac van 24 work as part of a crew. Each crew customarily has a day shift and a night shift. Each shift has an engineer responsible for the frac van controls. There will typically be several different engineers at the controls of the frac van over the course of a frac design process. These individual engineers bring with them varying personalities, knowledge, experience, and risk tolerance. The result is that individual engineers may respond differently to the information being monitored in the frac van 24. Some engineers may be quick to make adjustments, others may react more slowly. Use of a program based on “machine learning,” or “artificial intelligence,” can ensure that normal fluctuations in a frac process receive a consistent response, thereby providing a more uniform response and process across all shifts and crews.

A typical response in the frac van 24 to pressure issues is to increase friction reducer dosing, cut or lower the pump rate, and finally cut or lower sand loading. There is a cost factor to each response. By standardizing the reaction to normal fluctuations, a reduction in time and costs is possible. At a minimum, the uniformity available from use of a “machine learning” process would help an operator company anticipate and estimate “authorization for expenditure” costs across wells in the same field, or put another way, the itemized bill for the completion process.

Due to the precision pre-programmed into the “machine learned” controller, constant adjustments can be made to the formula of coated proppant being produced by the mobile coating unit 30 and then pumped into the well. The result is that the pre-determined, best possible, frac design parameters can be followed with less risk of human error. This is not possible with a human engineer at the controls because the human engineer is not capable of constantly increasing and decreasing the applicable parameters, i.e., friction reducer concentration. This real-time optimization means that no more chemical than necessary must be used, which saves costs and improves the project's ESG (environment, social and governance) impact.

In one embodiment, a coating system may be modified and configured to provide coated sand where the coating system is incorporated into an appropriate piece of equipment that is already at a well-site. Put another way, a piece of equipment on a well-site may be replaced with a proppant coating system without significantly altering the normal operation of the well-site. For example, a well-site may typically include large, conical mixers that have capacities similar to that of some on-site storage silos (i.e., 125-200 tons). These mixers, conical mixers or silo-mixers, would be able to hold enough sand, accept coating inputs, and create the required mixing action to create a coated proppant. Such a configuration would greatly reduce the space needed to coat a proppant on-site.

An appropriate process may include the following steps, provided here as an example process. The steps may be modified to accommodate equipment and/or procedures at a given site.

Sand could arrive on-site as it would ordinarily when silos are being utilized for on-site sand storage. Customarily, the sand is picked up at the sand mine in pneumatic or bottom dump trailers (depending on the silo system), transported to location, and off-loaded into the silo, or as described herein, into the silo-mixer.

In some embodiments, the silo-mixer may be mounted on load-cells.

The silo-mixer may be connected to input feeders. These input feeders may be connected to input storage mechanisms that could contain the bulk powder or liquid additives (i.e., powder additive silos or containers, and liquid additive containers), as the case may be.

The input feeders may be controlled by a PLC control unit that could read the weight as measured by the load-cells and feed the inputs or additives in the appropriate order and amounts, while allowing enough time for mixing between additions in order to accomplish the desired coating.

The mixing may continue until the coated proppant product is ready to be utilized and discharged into a surge hopper that could meter the coated proppant product to the frac blender 20 at the desired rate.

Just as with typical sand storage silos, a silo-mixer could be positioned on-site in a group (generally referred to as a six-pack because there are usually a set of six on a site). This could allow for some of the silos to be receiving sand while others are in the coating or discharge process. The silo-mixers could function as raw sand silos as well, meaning raw sand could simply be loaded into the silo-mixer and discharge without the addition of any inputs, or without coating any sand, if so desired.

A coating system that works in less space, or limited space, can also work where more space is available. In one embodiment, a proppant coating system may be configured in such a manner that it can replace a piece of equipment that is usually available on a well-site. In one embodiment, a proppant coating system may be configured in a substantially vertical manner, even in such a manner as to be elevated off the ground of the well-site, perhaps still allowing other equipment to use or occupy the space under the proppant coating system.

In one embodiment, a proppant coating system may be described as replacing a piece of equipment that is already on the well-site. An existing piece of equipment may be converted and/or combined with a proppant coating system. Important on-site equipment pieces or components to any process of coating and delivering coated proppant to a frac blender may include: some type of sand storage; a conveyance system, or delivery system, for delivering proppant, like sand, into the coating system; the coating system, which may include input feeders and proppant coaters, i.e., liquid additive dispensers 40, volumetric powder dispensers 60, a coating mixer 50 or coating blender 50, and a PLC control unit 32; a conveyance system, or delivery system, for delivering coated proppant product into the frac blender; and the frac blender 20.

In one embodiment, a proppant coating system may begin with converting or combining the coating process system with sand storage. A sand box may be converted to include, or combined with, a proppant coating system. There are multiple configurations that could accomplish such a combination. For example, a sand box could be configured to function as the coating system. In another example, the rack that the boxes sit on could be converted into the coating system.

In one embodiment, a conveyance system, or a delivery system, could be converted to include a proppant coating system. The mechanisms used to deliver sand from sand storage to the frac blender may be converted into a system for delivering sand from sand storage to the coating system. Typically, sand is moved about on-site in one of three ways: belt, screw, or gravity. Appropriate belts or screws may be replaced with a coating system such that the sand is coated in route from sand storage to the frac blender. For example, the various components of a mobile coating unit 30 may be reconfigured to accommodate such a replacement. In one embodiment, the necessary components of a coating system may include liquid additive dispensers 40, volumetric powder dispensers 60, a coating mixer 50 or coating blender 50, and a PLC control unit 32, arranged, configured and connected in such a manner to replace a belt or screw delivery component.

In one embodiment, a proppant coating system may be combined with a frac blender. In yet another embodiment, a modular proppant coating system may be combined in a manner that utilizer all or part of the other replacement embodiments described herein. Such a modular system may be designed and configured to take up the least aggregate space possible. Similarly, such a modular system may be designed to be transportable, or mobile.

In one embodiment, a mobile coating unit 30 as described in at least FIGS. 3 and 4 may be configured in what may be described as a vertical, modular layout. Such a layout or design may configure and connect the components of the coating system in a manner that minimizes the space taken up by the coating unit. This reconfiguration may include substantially the same component pieces in a mobile coating unit 30, capable of producing the necessary throughput volumes, and be arranged on skids. The component pieces of a mobile coating unit may be utilized as they are normally, or the shape of the component pieces may be modified to improve the vertical configuration.

Referring to FIG. 8, in one embodiment, a vertical coating unit 80 may be configured to fit the space needs of a particular well-site. For example, a base 90 (or vertical support 90 or scaffold 90 or scaffolding 90) could be assembled on a well-site. A first module 82 (or lower module 82 or base container 82) may be mounted on the base 90, or scaffold 90. A second module 84 (or top module 84 or supplemental container 84) may be mounted atop the first module 82. The first module 82 and the second module 84 could be connected to each other in a manner that allows and enables flow from the top module 84 down to the lower module 82 and the components inside the lower module 82. A vertical coating unit 80 may be equipped with a proppant elevator 86, or sand elevator 86, or sand transporter 86, to provide sand to the top module for the coating process. A sand transporter 86 may be any suitable piece of equipment that can move sand from one place to another place. A vertical coating unit 80 may also include a vertical exit 88, or vertical dispenser 88, where coated sand product exits the vertical coating unit 80. Also, a vertical coating unit 80 may include one or more access ladders 92 so that technicians can monitor, maintain, and operate the equipment in the first and second modules.

In one embodiment, if tackifier and polymer existed in the top module 84, those inputs or additives could be connected to and fed down into the lower module 82 and the appropriate equipment in the lower module 82. Additionally, the base 90, or scaffold 90, of the vertical coating unit 80 may be designed and configured to allow the frac blender 20, or other appropriate equipment, to be positioned beneath the lower module 82 and the vertical exit 88. If the proppant coater were in the lower module 82, finished product could exit the vertical proppant coating unit 80 and be fed directly into the hopper on the front of the frac blender 20, or directly into the frac blender 20, or into equipment that could transport the finished product to the frac blender.

To allow for transportation of the vertical coating unit 80, the modules 82, 84 and base 90 could be easily disassembled and loaded onto a flatbed trailer. A truck could then transport that trailer and the component pieces of the vertical coating unit 80 (i.e., first module 82, second module 84, and scaffold 90) to another well-site where the modules could be easily and quickly reassembled.

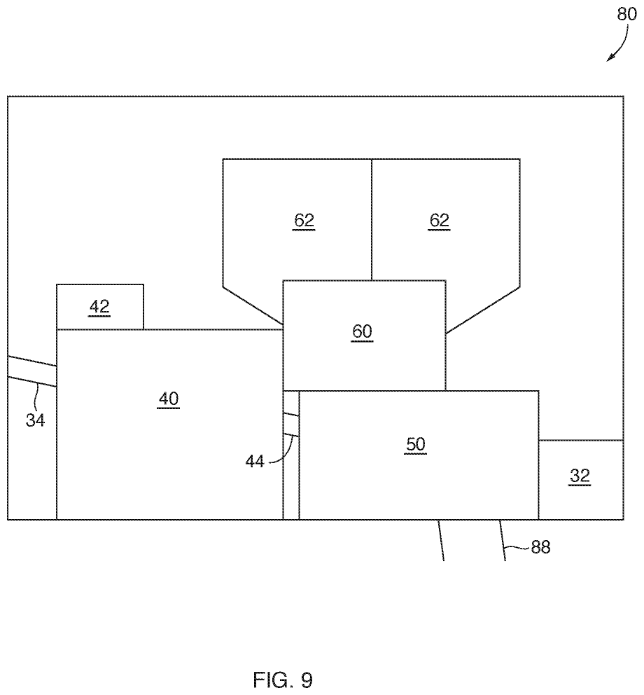

Referring to FIG. 9, in one embodiment, a vertical coating unit 80 may be comprised of various components and equipment. The individual equipment components may be arranged and connected in any suitable manner inside a vertical coating unit 80. For example, a charge hopper 34 may be positioned to allow entry of sand into the vertical coating unit 80. The charge hopper 34 may be operably connected to a sprayer 40, or liquid additive dispenser 40. The sprayer 40 may be connected to one or more liquid additives 42, or sources for liquid additives. As sand passes through the sprayer 40, sand may be sprayed with a desired liquid additive. A sand carrier 44 may be used to transport sand from the sprayer 40 to a coating blender 50, or coating mixer 50.

A volumetric powder dispenser 60 may be operably connected to the coating mixer 50. The volumetric powder dispenser 60 may dispense one or more powder additives to the coating mixer 50 and the sand therein. One or more powder additive silos 62, or sources for powder additives 62, may be connected to the volumetric powder dispenser 60 to allow multiple powder additives to be dispensed through the dispenser into the coating mixer 50.

After an appropriate time of mixing sand and any desired additives, powder or sprayed liquids, coated sand product may exit the coating mixer 50 via a vertical exit 88. A PLC control unit 32 may be used to control the operation of the vertical coating unit 80 and all the equipment and processes in the unit 80. The PLC control unit 32 may be operably connected to all the equipment in the vertical coating unit 80. The PLC control unit 32 may be operable connected to a frac van 24 on a well-site.

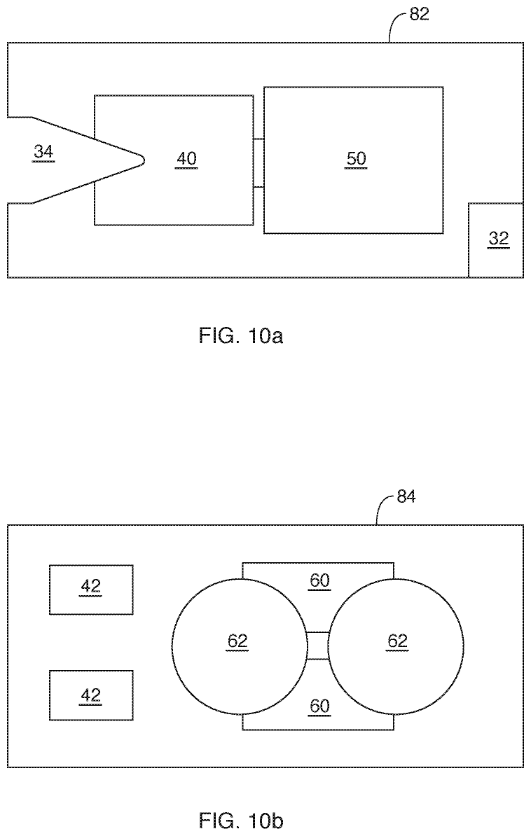

Referring to FIG. 10a, in one embodiment, a lower module 82 may include various components and equipment. The individual equipment components may be arranged and connected in any suitable manner inside a lower module 82. For example, a lower module 82 may contain a charge hopper 34, a liquid additive dispenser 40, a sand carrier 44, a coating mixer 50, and a PLC control unit 32.

Referring to FIG. 10b, in one embodiment, a top module 84 may include various components and equipment. The individual equipment components may be arranged and connected in any suitable manner inside a top module 84. For example, a top module 84 may contain liquid additives 42, one or more powder additive silos 62, and one or more volumetric powder dispensers 60.

The equipment and components in a lower module 82 and a top module 84 may be operably connected to work together in any suitable manner to provide coated proppant product. Also, the equipment and components in the lower module 82 and the top module 84 may be disconnected and stored so that the components and equipment may be transported within each module. Each module may have a size suitable for containing the components and equipment, and still be easily transportable. For example, a module may have a width of about eight (8) feet and a length of about forty (40) feet. Similarly, a module may have a width of about ten (10) feet and a length of about fifty (50) feet, or a length of about sixty (60) feet. Any suitable container width and length may be utilized.

There are many benefits to a vertical, modular design for a mobile coating unit based on the consideration of space alone, including at least the following. First, the mechanical equipment pieces are virtually identical and produce the volume and quality of coated proppant product necessary to meet the demands or multiple types of well-sites. Second, the ground footprint is virtually zero because the vertical coating unit 80 may be elevated, making the only ground-level space required by the unit is the square footage of the four feet of the base 90. Third, the elevated nature of the unit makes it so the unit does not interfere with hoses, cords, cables, and the like, since those can easily run unimpeded under the elevated unit. Fourth, since the flow of the process may work from the top module down, the unit is able to use gravity in the process where desired.

A vertical coating unit 80, may address other issues in addition to “space,” including but not limited to: (1) accommodating the use of the operator's desired sand size, from the operator's desired sand source; (2) accommodate the use of wet sand; and (3) reduce truck traffic from roads and frac site, while still providing all the modify-ability and benefits described herein.

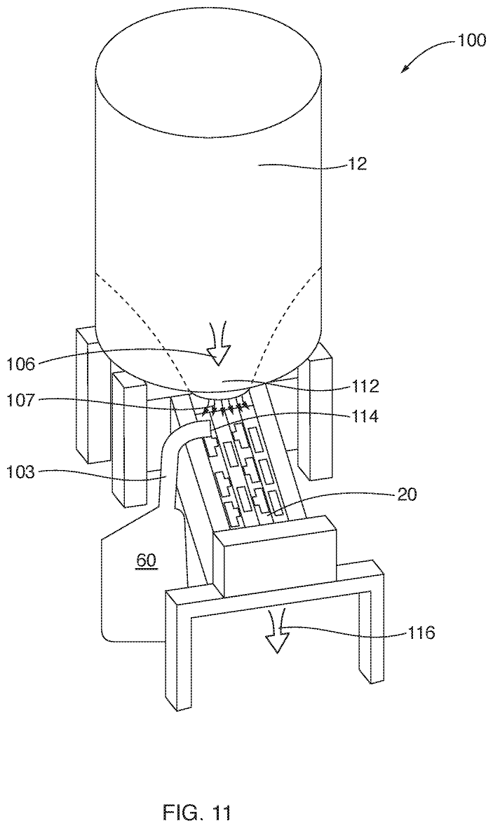

Referring to FIG. 11, a silo coating system 100 may have a configuration that allows for coating sand outside the silo 12. In one embodiment, a sand silo 12 may be configured to simply store stand, and/or it may be configured to mix sand, a silo-mixer 102. Either type of silo may be suitable for this embodiment. A sand silo 12 may contain an amount of sand, or proppant. The sand silo 12 may be supported by framing 103, or shared framing 103. The sand can be moved from the silo 12 to a blender 20 through a silo exit 106.

An input feeder 112, or liquid input feeder 112, or tackifier feeder 112, may be affixed or situated at or near the silo exit 106. Thus, a liquid additive, such as a tackifier, may be added to sand that is exiting the silo 12 and entering the blender 20 at or near a mixing point 107. The mixing point 107 is outside the silo 12. The liquid input feeder 112 may be connected to a source of liquid, or a source of tackifier, for example, a liquid additive dispenser 40.

Another input feeder 114, or polymer input feeder 114, or powder feeder 114, may be affixed or situated at or near the silo exit 106. Thus, a powder additive, such as a polymer, may be added to sand that is exiting the silo 12 and entering the blender 20 at or near a mixing point 107. The mixing point 107 is outside the silo 12. The polymer input feeder 114 may be connected to a source of polymer, for example, a volumetric powder dispenser 60.

A suitable control unit 32 may be used to control all the necessary functions for the silo 12, the blender 20, the liquid input feeder 112, and/or the polymer input feeder 114.

The silo coating system 100 may be configured in any suitable manner that provides desired, coated proppant, which may be delivered through the silo product output 116.

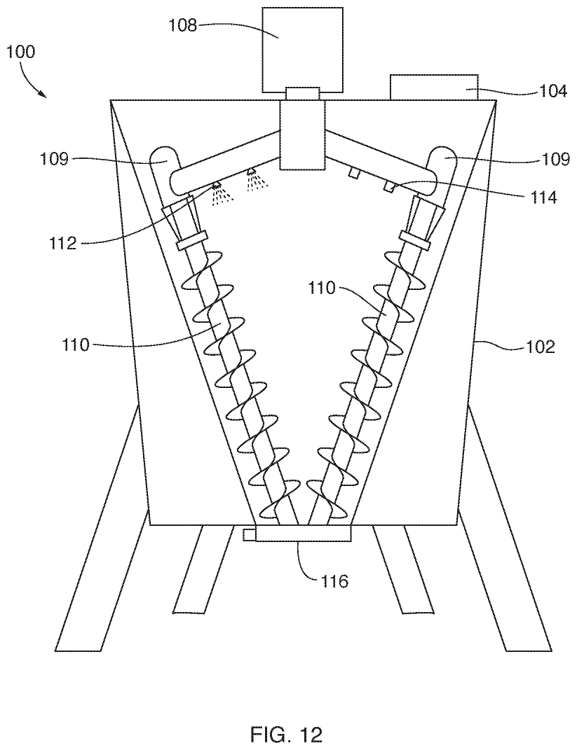

Referring to FIG. 12, a silo coating system 100 may have a configuration that allows for coating sand inside a silo-mixer 102. In one embodiment, a silo-mixer 102 may be configured to contain sand and to mix the sand before it exits the silo-mixer. A silo input 104, or sand input 104, may be configured to provide sand that is deposited into the silo-mixer 102. A silo motor 108 may be utilized to rotate one or more silo shafts 110 within a silo-mixer 102. One or more shaft motors 109 may be utilized to spin the silo shafts 110 within the silo-mixer 102. Thus, a more complete mixing of the sand, and any additives that may be deposited with the sand, can be more thoroughly mixed.

An input feeder 112, or liquid input feeder 112, or tackifier feeder 112, may be affixed or situated at or near the top or opening of the silo-mixer 102. Thus, a liquid additive, such as a tackifier, may be added to sand that is inside the silo-mixer 102. The liquid input feeder 112 may be connected to a source of liquid, or a source of tackifier, for example, a liquid additive dispenser 40.

Another input feeder 114, or polymer input feeder 114, or powder feeder 114, may be affixed or situated at or near the top or opening of the silo-mixer 102. Thus, a powder additive, such as a polymer, may be added to sand that is inside the silo-mixer 102. The polymer input feeder 114 may be connected to a source of polymer, for example, a volumetric powder dispenser 60.

A suitable control unit 32 may be used to control all the necessary functions for the silo-mixer 102, the liquid input feeder 112, and/or the polymer input feeder 114.

The silo coating system 100 may be configured in any suitable manner that provides desired, coated proppant, which may be delivered through the silo product output 116.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A sand coating system, comprising:
a sand carrier operably connected to transport an amount of sand to a coating mixer, wherein the coating mixer comprises a vertical exit that dispenses coated sand in a downward direction;
a liquid additive dispenser operably connected to spray a liquid additive onto the amount of sand before the amount of sand is transported into the coating mixer;
a volumetric powder dispenser operably connected to add an amount of powder additive to the coating mixer;
a control unit operably connected to the sand carrier, the liquid additive dispenser, the volumetric powder dispenser, and the coating mixer in a manner that enables the control unit to control the functionality of each; and
a scaffold that supports the sand carrier, the liquid additive dispenser, the volumetric powder dispenser, and the coating mixer, and defines a footprint of the system.

2. The sand coating system of claim 1, wherein the sand carrier, the liquid additive dispenser, the coating mixer, and the control unit are substantially contained within a lower container, and the lower container is transportable; and
wherein the volumetric powder dispenser is substantially contained within a top container, and the top container is transportable.

3. The sand coating system of claim 1, wherein the system footprint is less than about ten feet wide and about fifty feet long.

4. The sand coating system of claim 1, further comprising:
a charge hopper operably connected to provide sand to the sand carrier and is operably connected to the control unit.

5. The sand coating system of claim 4, further comprising:
a sand transporter operably connected to provide sand to the charge hopper.

6. The sand coating system of claim 1, further comprising:
one or more powder additive silos operably connected to provide powder additives to the volumetric powder dispenser; and
one or more liquid additives that can be sprayed by the liquid additive dispenser.

7. The sand coating system of claim 1, wherein the control unit is operably connected to a frac van.

8. The sand coating system of claim 1, wherein the vertical exit dispenses coated sand into a blender.

9. The sand coating system of claim 1, wherein the vertical exit is at least four feet above the ground where the system is located.

10. A system for coating a proppant, comprising:
a proppant carrier operably connected to transport an amount of proppant to a coating mixer, wherein the coating mixer comprises a vertical exit that dispenses coated proppant;
a liquid additive dispenser operably connected to spray a liquid additive onto the amount of proppant before the amount of proppant is transported into the coating mixer;
a volumetric powder dispenser operably connected to add an amount of powder additive to the coating mixer;
a control unit operably connected to the proppant carrier, the liquid additive dispenser, the volumetric powder dispenser, and the coating mixer in a manner that enables the control unit to control the functionality of each; and
a scaffold located on a well-site that supports the proppant carrier, the liquid additive dispenser, the volumetric powder dispenser, and the coating mixer, and defines a footprint on the well-site for the system, and supports the system such that the vertical exit is at least five feet above the well-site.

11. The system of claim 10, further comprising:
a charge hopper operably connected to provide proppant to the proppant carrier and is operably connected to the control unit.

12. The system of claim 11, further comprising:
one or more powder additive silos operably connected to provide powder additives to the volumetric powder dispenser; and
one or more liquid additives that can be sprayed by the liquid additive dispenser.

13. The system of claim 12, wherein the control unit is operably connected to a frac van on the well-site and the control unit receives real-time, down-hole information provided to the control unit by the frac van.

14. The system of claim 13, wherein the proppant is sand.

15. The system of claim 13, wherein the footprint is less than about ten feet wide and about sixty feet long.

16. A system for coating sand at a well-site, comprising:
a silo-mixer containing an amount of sand;
a first input feeder operably connected to the silo-mixer in a manner that allows an additive to be introduced into the silo-mixer via the first input feeder;
a first input storage mechanism operably connected to the first input feeder in a manner that enables the first input storage mechanism to provide the additive to the first input feeder; and
a control unit operably connected to the first input storage mechanism and to the silo-mixer in a manner that enables the control unit to control the functionality of each.

17. The system of claim 16, wherein the silo-mixer is mounted on one or more load-cells and the load-cells are operably connected to the control unit.

18. The system of claim 17, further comprising:
a second input feeder operably connected to the silo-mixer in a manner that allows a second additive to be introduced into the silo-mixer via the second input feeder;
a second input storage mechanism operably connected to the second input feeder in a manner that enables the second input storage mechanism to provide the second additive to the second input feeder, and the second additive is a powder additive; and
the second input storage mechanism is operably connected to the control unit.

19. The system of claim 16, wherein the control unit is operably connected to a frac van on the well-site and the control unit receives real-time, down-hole information provided to the control unit by the frac van.

20. The system of claim 19, wherein the silo-mixer is operably connected to a surge hopper in a manner that allows the silo-mixer to discharge coated sand into the surge hopper.
